(19) United States
(12) Patent Application Publication
(10) Pub. No.: US 2005/0252997 A1
(43) Pub. Date: Nov. 17, 2005

(54) Temperature-controlled oil spray nozzle for piston cooling

(76) Inventors: Roland Gluck, Ludwigsburg (DE); Hans-Jorg Kaifel, Winterbach (DE); Stephan Wagner, Fulda (DE)

Correspondence Address: KLAUS J. BACH, 4407 TWIN OAKS DRIVE, MURRYSVILLE, PA, 15668, US

(21) Appl. No.: 11/157,169

(22) Filed: Jun. 20, 2005

Related U.S. Application Data
(63) Continuation-in-part of application No. PCT/EP03/12873, filed on Nov. 18, 2003.

(30) Foreign Application Priority Data
Dec. 20, 2002 (DE) 102 61 180.7

(51) Int. Cl. B05B 1/32

(52) U.S. Cl. 239/541

(57) ABSTRACT

In a control valve for lubricating channels of motor vehicles, wherein a control element is associated with a control opening and biased by a first actuating member to an end position sealing the control opening and by means of a second actuating member which acts in an opposite direction, the pressure effective on the control element by lubricant via the control opening acts thereon in a perpendicular manner in relation to the direction of displacement of the control element so that no axial force is effective on the control element, the second actuating member consists of a memory metal which is activated at a predetermined temperature to move the control element out of its closing position against a stop element which is replaceably mounted on the valve housing.

This is a Continuation-In-Part Application of International Application PCT/EP03/12873 filed Nov. 18, 2003 and claiming the priority of German application 102 61 180.7 filed Dec. 20, 2002.

### BACKGROUND OF THE INVENTION

The invention relates to a control valve for lubricant ducts of motor vehicles, including a control member for a control port, which is biased within the control valve housing by a first actuating member into an end position for closing the control port and by a second actuating member to an open position against the biasing force of the first actuating member, the control member being a piston which is guided within a cylindrical recess of the regulating valve housing, and the control port being provided in a cylindrical guide face for the control member, so that the pressure force effective on the control member by the lubricant via the control port is directed perpendicularly to the direction of movement of the control member, the second actuating member being formed from a memory alloy.

A piston cooling system for internal combustion engines is already known from DE 35 37 147 A1, wherein oil is sprayed against the piston locations to be cooled. The device consists of a control valve which controls the circulation flow of lubricating oil as a function of the oil temperature. The control valve is in this case controlled by a first spring and an oppositely acting second spring which consists of a memory alloy.

JP 06 185642 A shows a control valve with an actuating member which is movable axially within a bush and which is not affected by the differential pressure on account of an opening. In addition, the actuating member shown is biased in the closing direction via a first actuating structure in the direction of a control port disposed radially with respect to the actuating member. Moreover, a second actuating structure is provided, which is formed from thermal wax and which, by virtue of a specific thermal expansion, at least partially cancels the closing force generated by the first actuating structure. Thus, owing to a reduced closing force, the actuating member can be moved axially by the prevailing oil flow and release the control port. The opening force on the actuating member is thus varied via the thermal-wax actuating structure.

The publication JP 09 324627 A likewise shows a regulating valve for a lubricating or cooling oil. It includes a control piston whose position is controlled by an endface ratio and the correspondingly prevailing differential pressure. A dependence of the position of the control piston on the temperature is not shown.

The publication JP 61 244820 A discloses a control member which is formed from a memory alloy and which, on account of its thermally induced intrinsic deformation, experiences a diameter variation or reduction, so that, at a corresponding temperature, the radially oriented control port is opened by means of the narrowing control member. An axial adjustment of the control member and the use of one or two actuating parts are not provided.

US 2003/005893 A1 likewise shows a control valve with an axially guided control member which is moved into the closed position by a spring force and into the open position by the prevailing oil pressure. No thermal element is provided in this case.

U.S. Pat. No. 5,819,692 A also shows an axially guided control member which is held in its closing position by a first actuating member. By a second actuating member based on thermal wax, the closing force of the first actuating member can be canceled in the corresponding temperature range so that the actuating member is brought into a position opening the oil duct. Both the first actuating member which is a spring and the second actuating member including the thermal wax act directly on the control member and generate oppositely directed axial actuating forces.

It is the object of the present invention to provide a control valve for lubricant ducts with which a simple setup can be established.

### SUMMARY OF THE INVENTION

In a control valve for lubricating channels of motor vehicles, wherein a control element is associated with a control opening and biased by a first actuating member to an end position sealing the control opening and by means of a second actuating member which acts in an opposite direction, the pressure effective on the control element by lubricant via the control opening acts thereon in a perpendicular manner in relation to the direction of displacement of the control element so that no axial force is effective on the control element, the second actuating member consists of a memory metal which is activated at a predetermined temperature to move the control element out of its closing position against a stop element which is replaceably mounted on the valve housing.

As a result, the stop element can be removed for the purpose of mounting the control member. It is also possible for the stop element to be exchanged in a simple way. In addition, the actuating forces of the control member are virtually independent of the pressure force of the lubricant. The force acting on the control member by means of the lubricant is absorbed by the control member guide or the control valve housing. The first and second actuating members may be correspondingly small.

The design as a piston ensures a simple and relatively low-friction guidance for the control member. Moreover, the stops which restrict the control member can be implemented in a simple way.

Furthermore, it is advantageous that the first actuating member and/or the second actuating member are/is designed as a spring element, particularly as a helical, spiral or leaf spring. The cylinder-like or piston-like design of the control member is conducive to the use of helical springs.

It is also advantageous, in this respect, that the control valve housing has a sleeve for the control member, the control port being arranged in the liner. The sleeve and the control member may be manufactured from hardened material and be inserted into the control valve. The sleeve can be exchanged in a simple way, depending on control parameters, in order to change the control times of the control valve. Also wear phenomena of the control member or of the liner can thus be eliminated in a simple way.

In a particular embodiment, the first actuating members or both actuating members is or are formed from a memory alloy. Due to the use of the memory alloy, the actuating movement of the respective actuating member, in conjunction with a relatively low pressure-independent actuating force, is ensured.

It is particularly important for the present invention that the first actuating member is arranged and engaged between the control member and the stop element and the second actuating member is arranged and engaged between the control member and the regulating valve housing. The desired biasing force on of the control member can thus be ensured.

In connection with the design and arrangement according to the invention, it is advantageous that, in every position, the control member can be acted upon on both sides with the same lubricant pressure in respect of its axial adjusting movement. The control movement is therefore influenced only insignificantly by the lubricant pressure prevailing at the control member.

It is advantageous, furthermore, that the control port includes at least two outlet ports for lubricant or at least two lubricant nozzles, and a common control valve is provided for the lubricant nozzles for various cylinders.

Finally, in a preferred embodiment of the invention, a control valve housing is provided with a cylindrical recess having four diameter steps D1 to D4, for the sleeve, the smallest diameter step D1 being designed as an inlet port for lubricant, and the sleeve being mounted in the second diameter step D2 adjoining the smallest diameter step D1. The liner likewise is cylindrical and its outside diameter corresponds to the diameter of the second diameter step D2. In this case, the sleeve has the control port in the region of a third diameter step D3, adjacent to the second diameter step D2, of the control valve housing. An annular duct is formed between the third diameter step D3 and the sleeve. The sleeve thus has a cylindrical recess, matching the recess at the transition from the first diameter d1 to a larger second diameter d2 adjacent the step transition between the two diameter steps d1, d2 forming a stop face for the control member. The third diameter step D3 and the sleeve are delimited by the stop element which is arranged within a fourth diameter step D4 of the recess, said fourth diameter step being adjacent to the third diameter step D3.

The invention will become more readily apparent from the following description of a particular embodiment thereof on the basis of the accompanying drawings:

### BRIEF DESCRIPTION OF THE DRAWINGS

FIG. 1 is a sectional view of a control valve in the closed position of the control port; and

FIG. 2 is a sectional view of the control valve in the open position of the control port.

### DESCRIPTION OF A PREFERRED EMBODIMENT

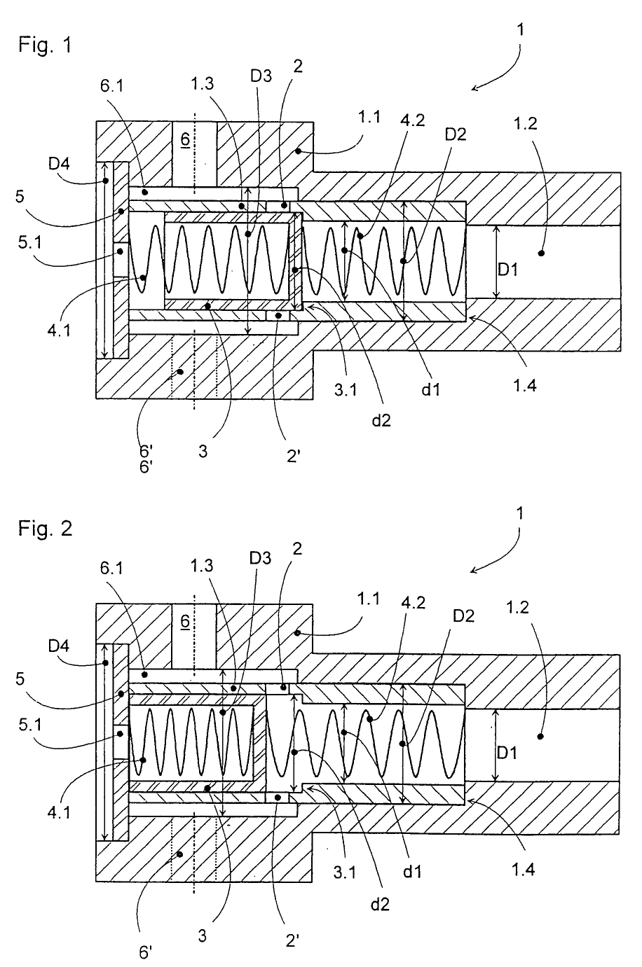

A control valve 1 according to FIG. 1 has a control valve housing 1.1 which includes within a central recess 1.2 a sleeve 1.3 with a control member 3 guided therein.

The opening 1.2 is in this case cylindrical and has four diameter steps D1-D4. The opening 1.2 is used, in the region of the smallest diameter step D1, on the right side according to FIG. 1, as an inlet port for lubricant. The sleeve 1.3 is mounted within the adjoining second diameter step D2 of the opening 1.2. The sleeve 1.3 is likewise cylindrical, its outside diameter corresponding to the diameter of the second diameter step D2 of the housing opening.

The sleeve 1.3 has a control port 2 in the region of a third diameter step D3 adjacent to the second diameter step D2. Between the third diameter step D3 and the sleeve 1.3, an annular duct 6.1 is formed on account of the difference in diameter between the sleeve 1.3 and the housing opening diameter step D3.

The sleeve 1.3 has a cylindrical opening with a first diameter d1 matching about the opening D1 of the housing, and with a second diameter d2 adjacent to the latter. The second diameter d2 is in this larger, the stepped transition forming a stop face 3.1 for a control member 3.

The control member 3 is axially movably supported within the second diameter opening d2 of the sleeve 1.3. The control member 3 is a piston which is open at one end and has a closed end face at the other end matching the stop face 3.1.

The third diameter step D3 and the sleeve 1.3 are in this case delimited by a stop element 5 which is arranged within a fourth diameter opening D4, adjacent to the third diameter opening D3, of the recess 1.2.

The control movement of the control member 3 is thus limited, on the one hand, by the stop face 3.1 and, on the other hand, by the stop element 5.

The axial position of the control member 3 is determined by a first actuating member 4.1 and an oppositely acting second actuating member 4.2. Both actuating members 4.1, 4.2 are in this case helical springs and bias the control member 3 in opposite directions. The first actuating member 4.1 bears, on the one hand, against the stop element 5 and, on the other hand, against the control member 3 or against the end face of the latter. The second actuating member 4.2 bears, on the one hand, against the end face of the control member 3 and, on the other hand, against the housing shoulder 1.4 between the first diameter step D1 and the second diameter step D2 and the recess 1.2.

The control valve housing 1.1 is larger and has an opening larger in diameter than the outer diameter of the liner 1.3, at least in the region of the third diameter step D3, so that an annular lubricant duct 6.1 is formed around the sleeve and lubricant can flow out from the inlet opening 1.2 via the control port 2 and the annular duct 6.1 into an outlet duct 6. An outlet duct 6 is arranged within the control valve housing 1.1 radially with respect to the cylindrical opening 1.2 or to the sleeve 1.3. In addition to the outlet duct 6, a second outlet duct 6′ may be provided so as to be offset circumferentially of the control valve housing 1.1.

The stop element 5 has a central opening 5.1 which ensures a movement of the control member 3 independent of the lubricant pressure. Moreover, the stop element 5 forms the axial step for the control member 3 toward the left side according to FIG. 2.

As shown in FIG. 2 the control member 3 is in the open position in which the control port 2 is opened. The lubricant admitted to the opening 1.2 can then flow via the control port 2 and the annular duct 6.1 into the outlet duct 6 to the lubricant nozzles, not illustrated. In the open position of the valve, a first actuating member 4.1 is compressed further while a second actuating member 4.2 is correspondingly expanded or relaxed. The second actuating member 4.2 consists in this case of a memory alloy which, when a specific temperature is reached, ensures that the second actuating member 4.2 is biased to the open position as illustrated in FIG. 2.

1. A temperature controlled oil spray nozzle valve (1) for piston cooling, comprising a valve housing (1.1) having a cylindrical opening (1.2) of stepped increasing diameter sections (D1 to D4), a radial control part (2) formed in said housing (1.1), a control piston (3) disposed in said cylindrical opening (1.2) so as to be movable relative to said control port (2) for closing or, respectively opening said control port (2), at least a first actuating member (4.1) disposed in said cylindrical opening (1.2) so as to bias said control piston (3) into an end position in which it closes the radial control port (2) and a second actuating member (4.2) disposed in said cylindrical opening (1.2) for biasing the control piston (3) in opposition to the first actuating member (4.1) which holds the control piston (3) in a port closing control position, said control port (2) extending perpendicularly to the direction of movement of the control piston (3) so that no axial fluid forces are effective on the piston (3) by the lubricant via the control port (2), said second actuating member (4.2) consisting of a memory alloy for biasing the piston (3) toward a stop element (5) for opening the port (2) when lubricant surrounding the second actuating member (4.2) reaches a predetermined temperature, said stop element (3) being releasably mounted to the control valve housing (1.1).

2. The device as claimed in claim 1, wherein the first actuating member (4.1) and the second actuating member (4.2) are spiral spring elements.

3. The device as claimed in claim 1, wherein the control valve housing (1.1) includes a sleeve (1.3) for supporting the control member (3), the control port (2) being arranged in the sleeve (1.3).

4. The device as claimed in claim 1, wherein at least the first actuating member (4.1) consists of a memory alloy.

5. The device as claimed in claim 1, wherein the first actuating member (4.1) is arranged and engaged between the control member (3) and the stop element (5), and the second actuating member (4.2) is arranged and engaged between the control member (3) and the control valve housing (1.1).

6. The device as claimed in claim 1, wherein, in each position, the control member (3) is exposed on both sides to the same lubricant pressure such that its movement is unaffected by the lubricant pressure.

7. The device as claimed in claim 1, wherein at least two outlet ports are provided for supplying lubricant to at least two lubricant spray nozzles.

8. The device as claimed in claim 1, wherein a common regulating valve (1) is provided for a plurality of lubricant spray nozzles for various cylinders.

9. The device as claimed in claim 3, comprising a control valve housing (1.1) with a cylindrical opening (1.2), having four stepped diameters D1 to D4, the sleeve (1.3) being supported in the housing opening section with the diameter D2 next to the smallest diameter section with the diameter D1 which is an inlet port for lubricant entering the valve (1).

10. The device as claimed in claim 9, wherein the sleeve (1.3) is also cylindrical and its outside diameter corresponding to the diameter of the second section with the diameter D2 so as to be snugly received therein.

11. The device as claimed in claim 3, wherein the control port (2) of the sleeve (1.3) is arranged in the region of a third diameter step D3 adjacent to the second diameter step D2 of the control valve housing (1.1), an annular space forming a duct (6.1) being provided between the third diameter step D3 and the sleeve (1.3).

12. The device as claimed in claim 3, wherein the sleeve (1.3) has a cylindrical opening with a diameter (d1) matching essentially the opening (1.2) of the first housing opening section with the diameter D1 and a larger second opening with a diameter d2 adjacent to the latter, the stepped transition between the two diameter sections forming a stop face (3.1) for the control member (3).

13. The device as claimed in claim 3, wherein the third housing opening section diameter step D3 and the sleeve (1.3) are delimited by the stop element (5) which is arranged within a fourth section with a diameter step D4 of he opening (1.2), said fourth diameter step section being adjacent to the third diameter step section D3.
